(19) United States
(12) Patent Application Publication
(10) Pub. No.: US 2004/0262168 A1
(43) Pub. Date: Dec. 30, 2004

(54) Methods of electopolishing patterned substrates

(76) Inventors: Jinshan Huo, Naperville, IL (US); James McAndrew, Homer Glen, IL (US); Rajendra Solanki, Portland, OR (US)

Correspondence Address: Linda K. Russell, Air Liquide, Suite 1800, 2700 Post Oak Blvd., Houston, TX, 77056, US

(21) Appl. No.: 10/857,624

(22) Filed: Jun. 1, 2004

Related U.S. Application Data
(60) Provisional application No. 60/482,427, filed on Jun. 25, 2003.

(51) Int. Cl. B23H 3/00

(52) U.S. Cl. 205/676

(57) ABSTRACT

A method for planarizing an element using an electrochemical polishing process includes contacting a patterned substrate with a polishing solution including 1-hydroxyethylidene-1,1-diphosphonic acid (HEDP) while applying an electric potential to the substrate. The patterned substrate is preferably a copper electroplated trenched silicon wafer. The potential is maintained within a predetermined limiting current plateau. The resulting electrochemical reaction is limited by mass transport of the copper, and creates a salt film along the copper surface. The copper layer becomes planar due to ohmic leveling, migration smoothing, and diffusion smoothing. Using HEDP enables the planarization of the copper surface without causing dishing or without completely removing the copper from the wafer.

### CROSS-REFERENCE TO RELATED APPLICATION

This application claims priority from U.S. Provisional Patent Application Ser. No. 60/482,427, entitled “Methods of Planarizing Bulk Copper and Copper Electroplated Silicon Wafers” and filed Jun. 25, 2003. The disclosure of the above-mentioned provisional application is incorporated herein by reference in its entirety.

### BACKGROUND OF THE INVENTION

1. Field of the Invention

The present invention pertains to compositions and methods for removing a conductive material from a substrate. In particular, this invention relates to methods and apparatuses for electropolishing metal layers on semiconductor wafers.

2. Related Art

Reliably producing sub-micron and smaller features is one of the key technologies for the next generation of very large scale integration (VLSI) and ultra large-scale integration (ULSI) of semiconductor devices. However, as the fringes of circuit technology are pressed, the shrinking dimensions of interconnects in VLSI and ULSI technology have placed additional demands on the processing capabilities. The multilevel interconnects that lie at the heart of this technology require precise processing of high aspect ratio features, such as vias and other interconnects. Reliable formation of these interconnects is very important to VLSI and ULSI success and to the continued effort to increase circuit density and quality of individual substrates.

Currently, copper and its alloys have become the metals of choice for sub-micron interconnect technology because copper has a lower resistance than aluminum, (1.7 μΩ-cm compared to 3.1 μΩ-cm for aluminum), and a higher current carrying capacity and significantly higher electromigration resistance. These characteristics are important for supporting the higher current densities experienced at high levels of integration and increased device speed. Further, copper has a good thermal conductivity and is available in a highly pure state.

Damascene is the most common technique used for fabricating copper interconnects in microelectronic devices. In this method, a substrate is provided with a dielectric layer (also called an interlayer dielectric (ILD)) that may be patterned, e.g., by etching, to form one or more apertures (e.g., channels, vias, and/or trenches). A conductive material, such as a copper, may be blanket deposited over the dielectric layer (using, e.g. electroplating) to fill the vias and trenches in the interlayer dielectric (ILD). As layers of materials are sequentially formed, the upper most surface of the substrate structure may become non-planar, having a series of gentle undulations. As a result, a non-planar substrate surface may require planarization prior to further processing. Planarizing or polishing a substrate surface is a process intended to remove material from the substrate surface to form a more planar substrate surface. Planarization is also useful in removing excess deposited material used to fill the features and in removing undesired surface topography, such as surface defects, agglomerated materials, crystal lattice damage, scratches, and contaminated layers or materials.

In damascene, the excess Cu is removed using chemical mechanical polishing (CMP), in which a slurry including mechanically hard abrasives contacts the deposited metal layer while a polishing pad is used to planarize the layer's surface. CMP processes, however, are becoming increasingly harder to implement. In order to reduce the capacitance between interconnects, a lower dielectric constant (k) ILD material is required. At present, carbon-doped silica (SiOC) films formed by chemical vapor deposition (CVD) are competing with polymeric, spin-on dielectric (SOD) films to replace the current standard, fluorosilicate glass (FSG) and silicon dioxide (SiO₂) films. When CMP processes are used with these softer ILDs, problems arise, such as (1) the embedding of slurry particles into the ILD material (which contaminates the ILD and increases the k value); (2) the crushing of the ILD by the pressure applied during CMP; (3) the scratching of the ILD surface; and (4) the peeling off of the ILD layer under the shear stress caused by CMP. Since future device generations will require ILDs with even lower dielectric constants (which can be achieved by introducing more porous, and thus softer ILDs), alternatives to CMP are needed.

Electrochemical polishing (also called electrochemical planarization, electropolishing, or electroplanarization) is a non-mechanical (stress-free) technique being explored to remove conductive material from a substrate surface. In electrochemical polishing (ECP), a potential (e.g., an anodic bias) is applied to the substrate surface to remove conductive material, such as copper, by an ion dissolution mechanism. One problem with conventional electropolishing techniques is that the non-planar substrate is not sufficiently planarized before a portion of the conductive layer is completely removed (down to the dielectric layer) or (2) is not sufficiently planarized without causing dishing of the copper filling the apertures. Hence, improved ECP techniques are urgently needed.

ECP can be subdivided into leveling (or macrosmoothing) and brightening (or microsmoothing). Leveling, which refers to the elimination of larger surface roughness (i.e., a mean roughness of 1 μm or more), occurs when a uniform potential is applied to a rough surface. As a result, peaks of a rough surface have higher dissolution rate than the valleys. R. Soutebin and D. Landolt, Anodic Leveling under Secondary and Tertiary Current Distribution Conditions, J. Electrochem. Soc., 129, 946-953 (1982) and R. Soutebin H. Froidevaux, and D. Landolt, Theoretical and Experimental Modeling of Surface Leveling in ECM under Primary Current Distribution Conditions, J. Electrochem. Soc., 127, 1096-1100 (1982), both references incorporated herein by reference in their entirety.

Brightening, which refers to the elimination of surface roughness comparable to the wavelength of visible light (i.e. mean roughness value (Rₐ) of up to about 1 μm), is due to the formation of certain kinds of diffusion barrier layers on the anode surface. While leveling can be achieved under either ohmic or mass transport control, brightening can be achieved only under mass transport control, which suppresses crystallographic etching. See, e.g., H. Abrams and C. L. Mantell, Electrolytic Polishing of Copper and Nickel Silver, Electrochem. Tech., 5, 287 (1967) and M. Matlosz, S. Magaino and D. Landolt, Impedance Analysis of a Model Mechanism for Acceptor-Limited Electropolishing, J. Electrochem. Soc., 141, 410-418 (1994), the disclosures of which are incorporated herein by reference in their entireties.

An understanding of the mass transport process under ECP conditions is, therefore, a prerequisite for optimizing process parameters such as electrolyte composition and operating voltage/current. A model has been proposed articulating that three types of transport limiting species exist within an ECP system: cation of dissolving metal (Mⁿ⁺) in anodic salt film, electrolyte anion (A^{m-}), and water molecules in the diffusion layer between anode and bulk solution. See D. Landolt, Fundamental Aspects of Electropolishing, Electrochim. Acta, Vol. 32, No. 1 (1987), 1-11, incorporated herein by reference in its entirety. However, this model cannot fully explain the experimental results obtained by other researchers. See J. Edwards, J. Electrochem. Soc., vol. 97 (1953), 223C-230C; R. Kirchheim et al., Diffusion and Solid-Film Formation During Electropolishing of Metals, J. Electrochem. Soc., Vol. 128 (1981), 1027-1034; and 1. L. Alanis and D. J. Schiffrin, The Influence of Mass Transfer on the Mechanism of Electropolishing of Nickel in Aqueous Sulphuric Acid, Electrochim. Acta, Vol. 27, No. 8 (1979), 837-845; each reference incorporated herein by reference its entirety. Additionally, more challenges arise when an ECP technique is applied to copper films electroplated on patterned silicon wafers. First, the patterned features of electroplated copper films are difficult to remove and may lead to non-uniform polishing. Second, over-etching of the copper in trenches often occurs because “end-point stopping” is difficult to control. Third, the surface of the copper films after ECP becomes rough instead of bright as a result of inhomogeneous etching and gas bubbles. See S. Sato et al., Newly Developed Electro-Chemical Polishing Process of Copper as Replacement of CMP suitable for Damascene Copper Inlaid in Fragile Low-k Dielectrics, IEEE 2001; M. H. Tsai et al., CMP-Free and CMP-Less Approaches for Multilevel Cu/low-k BEOL Integration, IEEE 2001; and M. Datta, Microfabrication by Electrochemical Metal Removal, IBM J. Res. Develop., 42, 5 (1998), 655-669, each reference incorporated herein by reference its entirety.

One study also found that ECP efficiency was influenced by the pattern of surface profile. See Shih-Chieh Chang, et al., Pattern Effects on Planarization Efficiency of Cu Electropolishing, Jpn. J. Appl. Phys. Vol. 41(12), Part 1, 7332-7337(2002), incorporated herein by reference its entirety. In addition, anode surface layers play a critical role in mass transport in an ECP process. One study suggested that a porous anodic layer was present on the copper surface of ECP of patterned wafers in phosphoric acid. See Shih-Chieh Chang et al., Microleveling Mechanisms and Applications of Electropolishing on Planarization of Copper Metallization, J. Vac. Sci. Technol. B 20(5) 2149-2153 (2002), incorporated herein by reference its entirety. Other research, however, has proposed that the mass transport is limited by an acceptor mechanism, with water as the most likely acceptor molecule. See R. Vidal and A. C. West, Copper Electropolishing in Concentrated Phosphoric Acid, J. Electrochem. Soc., Vol. 142, No. 8 (1995), 2682-2694 and D. Padhi et al., Planarization of Copper films by Electropolishing in Phosphoric Acid for ULSI Applications, J. Electrochem. Soc., Vol. 150, No. 1 (2003), G10-G14, both references incorporated herein by reference in their entireties. Probing of the anode layer is very challenging since it may break down when the potential is switched off and the anode is taken out of the electrolyte. Electrochemical Impedance Spectroscopy (EIS) has been used to study iron alloys and copper anode layers in H₃PO₄—H₂SO₄, FeCl₂, and H₃PO₄ electrolytes. See S. Magaino et al., An Impedance Study of Stainless Steel Electropolishing, J. Electrochem. Soc., Vol. 140, 1365-1373 (1993) and R. D. Grimm et al., AC Impedance Study of Anodically Formed Salt Films on Iron in Chloride Solution, J. Electrochem. Soc., Vol. 139, 1622-1629 (1992), both references incorporated herein by reference their entireties.

The ECP process, then, depends on many factors, including, for example, the type of electrolyte solution and its circulation in a processing chamber, disk (substrate) rotating speed, current density, potential, and temperature. Optimal ECP conditions for copper electropolishing for microelectronic applications are still not available. Consequently, it would be advantageous to determine the optimum conditions for copper ECP for microelectronic applications.

### SUMMARY OF THE INVENTION

An object of the present invention is to provide an electropolishing composition for dissolving at least a portion of a conductive material from the surface of a patterned substrate, wherein a substantially smooth and planar substrate is achieved.

Another object of the invention is to sufficiently planarize a patterned substrate including a conductive layer before a portion of the conductive layer is completely removed.

Yet another object of the invention is to provide an electropolishing process wherein a substrate including apertures electroplated with a layer of conductive material contacts an electrochemical polishing composition, and polishing is achieved without causing dishing of the copper filling the apertures.

The aforesaid objects are achieved individually and/or in combination, and it is not intended that the present invention be construed as requiring two or more of the objects to be combined unless expressly required by the claims attached hereto.

In accordance with the present invention, a method of planarizing an element is provided, the method including the steps of (1) contacting the element with an electropolishing composition including an electrolyte, wherein the electrolyte comprises 1-hydroxyethylidene-1,1-diphosphonic acid, and (2) applying an electric potential to the substrate, wherein the element includes at least one patterned layer and at least one layer comprising a conductive material.

To achieve the above and further objects, optimum conditions for copper ECP were determined by analyzing copper anodic layers in situ in solutions of (1) HEDP, (2) phosphoric acid, and (3) phosphoric acid with organic and inorganic additives were using Electrochemical Impedance Spectroscopy. Salt films formed in HEDP solutions were detected, but no salt film was found in the solutions containing phosphoric acid or phosphoric acid with copper oxide, ethylene glycol and sodium tripolyphosphate as additives.

The results indicate that while H₂O molecules are the mass transport controlling species in solutions of phosphoric acid and of phosphoric acid with copper oxide, Cu⁺⁺ ions are the mass transport controlling species in solutions of HEDP and of phosphoric acid with additives ethylene glycol or sodium tripolyphosphate. Desirable results of electropolishing of bulk copper disks were obtained in all the above solutions, but the electropolishing of electroplated copper films on patterned silicon wafers is more challenging. A satisfactory planarization effect for electropolishing of patterned silicon wafers was obtained only from solutions including HEDP as the electrolyte. Experimental results and theoretical analysis indicate that anodic salt films with macro surface profile are crucial conditions for electropolishing of electroplated copper films on patterned silicon wafers due to ion migration and ohmic leveling effects.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1A is an AFM topography image of the surface profile of copper bulk material.

FIG. 1B is an optical image of a plan view of an electroplated copper film on a patterned silicon wafer.

FIG. 1C is an SEM image of cross section of an electroplated copper film on a trenched silicon wafer.

FIGS. 2A and 2B show configurations of electrochemical impedance spectroscopy (EIS) system and silicon wafer holder.

FIG. 3 is a schematic of a boundary layer (δ) and diffusion layer (δ_{c}) on a sample surface under forced convection of solution.

FIG. 4A depicts a concentration gradient profile along a cross section of a boundary layer.

FIG. 4B depicts a concentration gradient profile along cross sections of a salt film and boundary layer.

FIG. 5A depicts a “double layer” including a diffusion layer and a mobile layer.

FIG. 5B is a schematic of an equivalent circuit of an electrode with a diffusion layer.

FIG. 5C is a theoretical impedance plot of an electrochemical cell.

FIG. 6A is a plot of EIS spectra obtained from a planarization process using 85% phosphoric acid.

FIG. 6B is a plot of EIS spectra obtained from a planarization process using a 60% phosphoric acid and 1.2 M CuO solution.

FIG. 6C is a plot of EIS spectra obtained from a planarization process using a 43% phosphoric acid and 50% ethylene glycol solution.

FIG. 6D is a plot of EIS spectra obtained from a planarization process using a 70 vol % HEDP (active acid 60 wt %) solution.

FIG. 6E is an EIS spectra obtained from a planarization process using a 60% phosphoric acid and 0.5 M sodium tripolyphosphate solution.

FIG. 7A is an SEM image of a copper surface after an ECP process using an 85% phosphoric acid solution.

FIG. 7B is an SEM image of a copper surface after an ECP process using a 70 vol % HEDP (60 wt % active acid) solution.

FIG. 8A is an AFM topography image of copper after ECP using 70% phosphoric acid and 5% ethylene glycol.

FIG. 8B is an SEM image in cross section of a wafer coupon after ECP using phosphoric acid.

FIG. 8C is an SEM image in cross section of a wafer coupon after ECP using 70 vol % HEDP (60 wt % active acid).

FIG. 9 is a cross-sectional illustration of a rough anode surface with uniform potential (V₁), wherein peaks have higher current density due to different inter electrode distance: Iₚ>I_{Q}.

FIG. 10 is a cross-sectional illustration of a salt film formed on anode surface that facilitates surface smoothing due to ion migration and/or ohmic smoothing effect.

FIG. 11A depicts a cross-sectional view of the cathode and the anode of an electropolishing cell.

FIG. 11B is a magnified view of a surface portion of the anodic material of FIG. 11A showing the local surface profile of the anode, wherein the electric field (E) varies in amplitude and orientation along the sinusoidal surface.

FIG. 12A is a graph of the amplitude of normal electric field along the sinusoidal anode surface, obtained by simulation.

FIG. 12B is a graph of the amplitude of normal electric field En(P) at the peak and En(Q) at the valley of the sinusoidal surface, versus the frequency of the sine wave.

### DESCRIPTION OF PREFERRED EMBODIMENTS

Briefly, in an electrochemical cell, an external voltage is applied to electrodes positioned in an electrolyte solution to force the oxidation/reduction processes to occur. Specifically, an external voltage is applied to the two electrodes—the first electrode is connected to the positive pole of the power supply (the anode) and the second to the negative pole of the power supply (cathode). When the applied voltage is sufficient, electrons in the anode may be pumped out and the metal atoms on the anode surface will be oxidized (e.g., Cu−2e→Cu⁺⁺) and dissolved into the electrolyte solution. Under electrical field, the positive ions (cations) move towards cathode and negative ions (anions) move towards anode. The cations may accept electrons and be reduced to atoms (e.g., Cu⁺⁺+2e→Cu) again at the cathode surface. Therefore, electron transfer between the two electrodes is carried out via the ion drift in the electrolyte solution and the electron conduction in a metal wire. When the working electrode is set to be anode (i.e., when an anodic potential is applied), dissolution takes place. Likewise, when the working electrode is set to be the cathode, deposition results.

For electropolishing of a substrate including a layer of conductive material (e.g., copper), a substrate is placed in electrical contact with one of the electrodes and, in effect, becomes an electrode for material removal. Specifically, the substrate to be polished is set to be the anode (i.e., an anodic potential is applied to the substrate), while any conductive material (e.g., copper) serves as the cathode. The entire system (electrode and substrate) is placed in an electropolishing solution. The solution typically comprises one or more electrolytes, as well as water (e.g., deionized water). With this configuration, metal atoms on a surface of a substrate are ionized by the electrical current from a source of potential (i.e., the voltage source connected to two electrodes), and metal ions dissolve into the surrounding polishing composition.

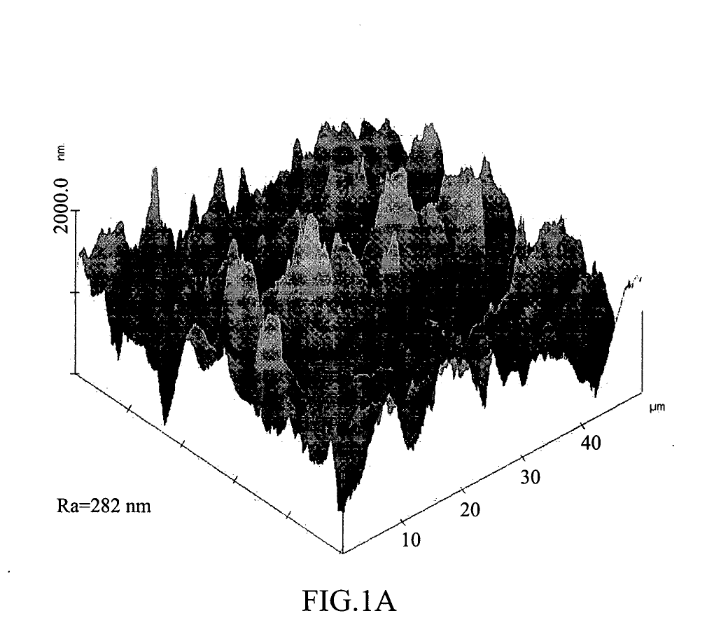

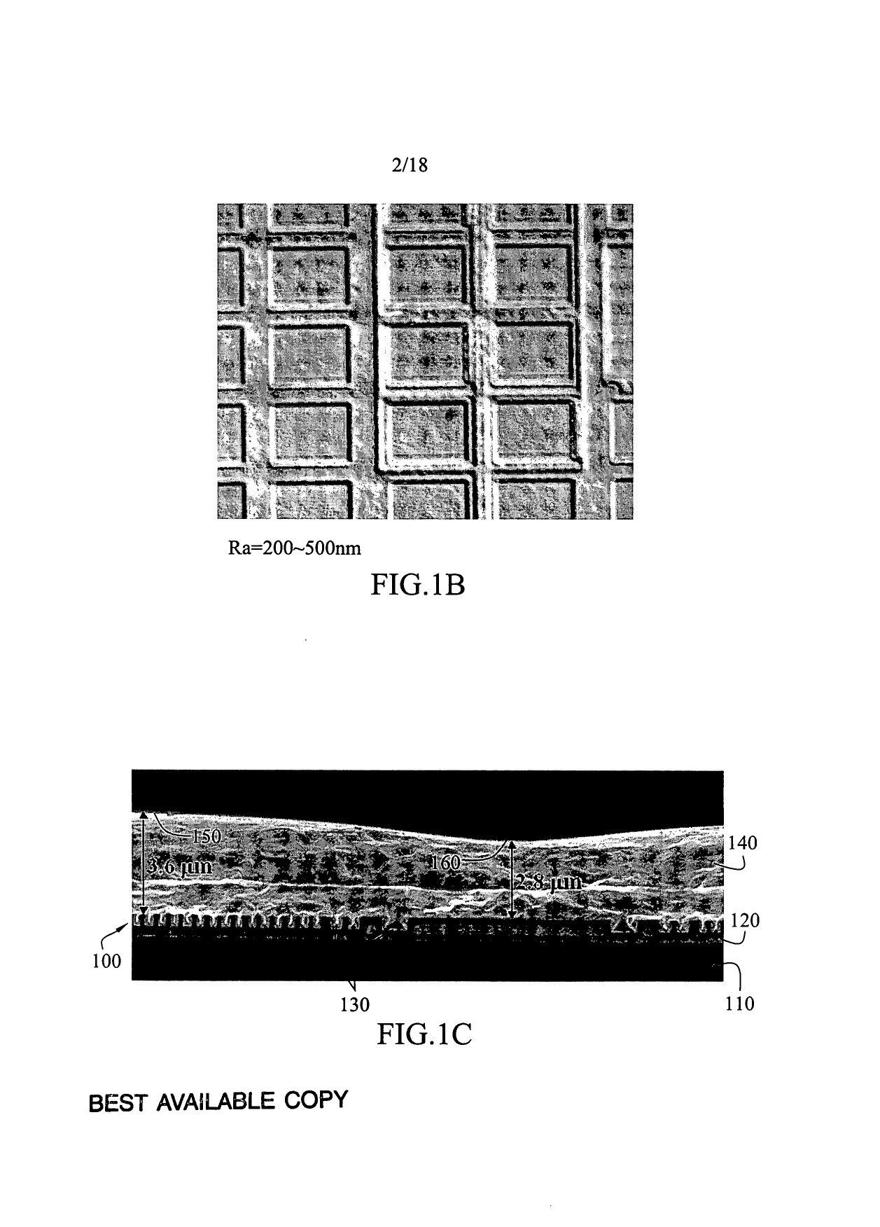

FIG. 1C is a cross-sectional SEM image of one embodiment of a semiconductor element 100 at one stage in the formation of a copper interconnect. Depending on the processing stage, the element 100 comprises a substrate 110, such as a semiconductor substrate or a glass substrate, and may include other materials formed over the substrate, such as a dielectric layer, conductive layer, and/or other layers. A dielectric layer 120, such as a silicon dioxide layer or a low-k material layer, may be formed over the substrate 110. The dielectric layer 120 may be patterned (by, e.g., etching) to form a patterned layer. The phrase “patterned layer” as used herein is a layer that includes at least one aperture 130. The term “aperture” as used herein refers to one or more of a via (a conducting pathway between two or more substrates), a groove, a trench, and a channel. An example of a patterned layer is a layer including vias and/or trenches. The dimensions of the apertures can be, for example, up to about 5 μm deep and up to about 0.13 μm wide (lateral width). A layer including conductive material 140 (e.g., copper) may be deposited over the dielectric layer 120 to fill the apertures 130. By way of example, the conductive material may be deposited using electroplating techniques. The thickness of the layer of conductive material 140 may be, for example less than 2 μm. A barrier layer (not shown), such as tantalum and/or tantalum nitride layer, may also be formed between the dielectric layer 120 and the conductive layer 140. Each of the above layers may be continuous or discontinuous.

As noted above, when layers of materials are sequentially formed, the uppermost surface of the substrate structure 100 may become non-planar. For example, the upper surface may include a gently undulating topography comprising bumps 150 (also called peaks or protuberances) and pads 160 (also called recesses or valleys). When measured from the patterned layer, the difference between the height of a bump 150 and the height of a pad 160 is called the step height. For example, the step height of the patterned substrate 100 shown in FIG. 1C is the difference of the bump 150 height (3.6 μm) and the pad 160 height (2.8 μm) is 0.8 μm (for a conductive material layer deposited at a thickness of about 3 μm). The step height is typically about 0.2 μm to about 0.5 μm for a conductive layer deposited at a thickness of about 1 μm.

FIG. 1A is an atomic force microscopy (AFM) image of the surface profile of copper bulk material. FIG. 1B is an optical image of a plan view of an electroplated copper film on a patterned silicon wafer. As noted above, FIG. 1C is a scanning electron microscopy (SEM) image of cross section of an electroplated copper film on a trenched silicon wafer. As shown in these Figures, the surface profile of a patterned substrate (e.g., an electroplated copper film on a trenched wafer) is quite different from that of non-patterned, normal bulk (copper disk) materials. The mechanically polished surface of bulk copper material has a rough surface with protrusions (FIG. 1A). However, as noted above, the surface of a copper film deposited on a patterned substrate (FIG. 1B) has a smoother surface, with a generally undulating topography including a series of pads (valleys) and bumps (peaks) that are approximately 0.2 to 0.8 μm higher than the pads. The bumps and pads correspond with the trenches and vias under the film. This is best seen from in cross section illustrated in FIG. 1C, which shows that the film at trench area is (3.6 μm) much thicker than the film (2.8 μm) at the area without trench or via. A non-patterned substrate (not shown) would lack these bumps and pads, since an non-patterned substrate would lack the apertures (e.g., vias and trenches) to create an undulating topography. It is desirable to even out these bumps to achieve substantially uniform planarization across areas of varying pattern density. A planar surface with a substantially uniform topography is a surface where the step height value is minimized, if not altogether eliminated. By way of example, the minimum step height value may be zero. To achieve substantially uniform planarization, a better understanding of the mass transport processes and ECP mechanisms is necessary to identify the factors that are effective in ECP of copper electroplated silicon wafers.

Experimental

Copper anodic layers were investigated in situ using Electrical Impedance Spectroscopy (EIS). Specifically, copper anodic layers in solutions of 1-hydroxyethylidene-1,1-diphosphonic acid (HEDP), phosphoric acid, and phosphoric acid with organic and inorganic additives were studied, and the effects of the anodic layers on mass transport under ECP conditions and on the ECP of copper disks (bulk material) as well as electroplated copper films on trenched wafers were analyzed.

Analysis of Copper Anodic Layer with Electrochemical Impedance Spectroscopy (EIS)

Electrochemical impedance spectroscopy (EIS) is a method in which a small alternating current (AC) signal is applied to an electrode and the resulting current is measured. The measuring instrument processes the current-time and voltage-time measurements to provide the impedance at different frequencies, i.e., the impedance spectrum. The electrode studied can be a corroding metal, for corrosion study, or an anode electrode in an electrochemical cell, for characterizing the anodic layers and electrochemical processes.

Impedance is the term used to describe the ac equivalent of direct current (DC) resistance. With DC methods, the total resistance of the system (polarization resistance Rₚ) can be obtained. When an ac signal is applied, an electrochemical cell or even a simple corrosion system behaves more complicated. One has to consider polarization resistance Rₚ, solution resistance Rₛ, and double layer capacitance C_{dl}. EIS can be used to identify and quantify these components and thus characterize the anodic layers and electrochemical processes.

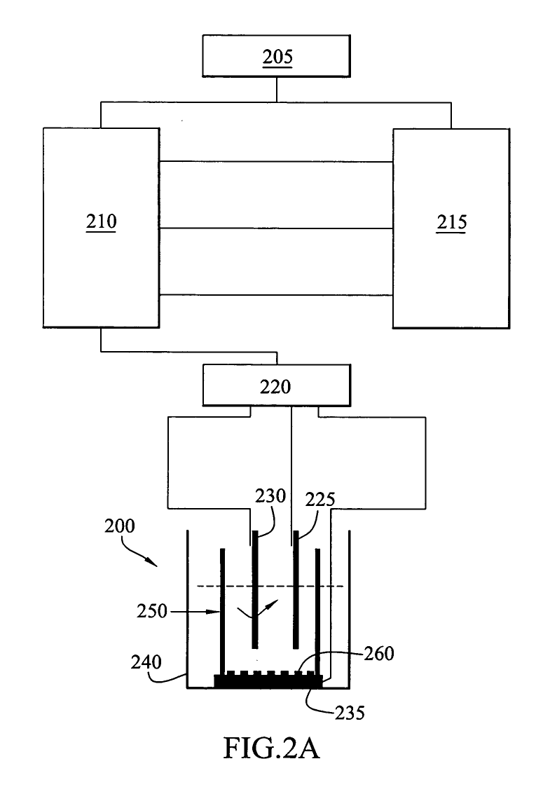

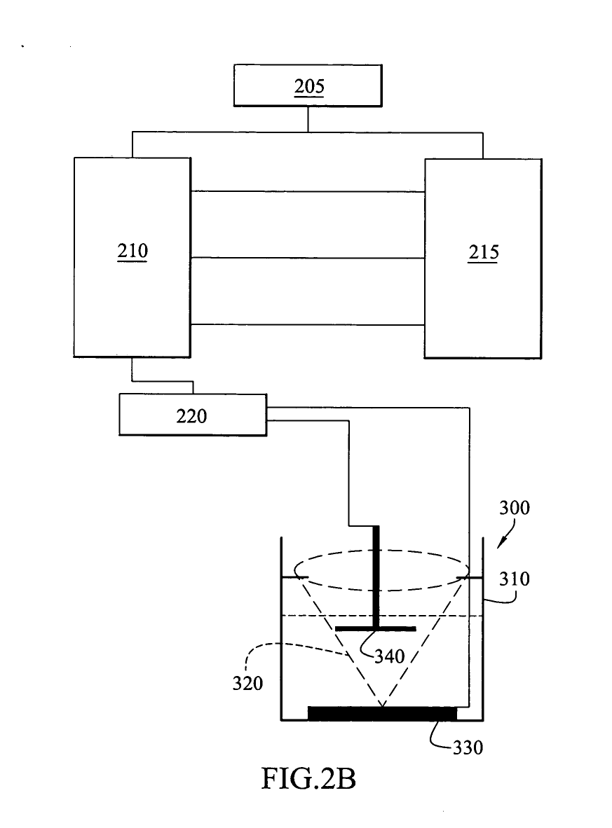

To measure the impedance of an anodic dissolution process and thus determine the presence or absence of a salt film, alternating current (AC) impedance analyses of copper anodic layer was carried out in aqueous solutions of hydroxyethylidenediphosphonic (HEDP) acid, phosphoric acid, and phosphoric acid with copper oxide, ethylene glycol and sodium tripolyphosphate. An exemplary embodiment of a phosphoric acid is 85% orthophosphoric acid. Referring to FIG. 2A, the typical analysis system 200 included a computer 205, a potentiostat 210 (e.g., a Princeton Applied Research 273A Potentiostat/Galvanostat), an impedance analyzer 215 (e.g., a SOLARTRON SI 1260 Impedance/Gain-Phase Analyzer), an electrometer 220, and a reference electrode 225 (e.g., a Ag/AgCl reference). The substrate (anode) samples 230 included copper disks with surface area of 1 cm² and 1.5 mm thickness. A 12 mm thick and 43 mm in diameter copper plate served as a cathode 235. The measurements were performed with “controlled E sweep frequency” under the following conditions: controlled DC voltage, AC signal of 10 mV and frequency range of 100 kHz to 0.1 Hz, 100 rpm anode 230 rotating speed, and room temperature. The process chamber 240 included a Teflon cylinder 250 with a filter 260 at the bottom. The process chamber 240 comprised a 200 ml glass container, and was filled with 100 mL solution. Before each measurement, a 50-second pretreatment was performed without the AC signal.

The EIS measured samples were examined with a scanning electron microscope (SEM) to correlate the results produced from impedance analysis. In each case the anode, after an ECP process in each solution, was carefully taken out of the electrolyte with the potential on. Then the anode was placed in vertical position so that the solution on the surface dropped down to the lower edge. The solution was carefully wiped off and the anode was dried with warm air. By following this procedure, the salt film (if present) on the anode surface was undamaged for SEM inspection.

Electrochemical Polishing of Electroplated Copper Films on Silicon Wafers and (Bulk) Copper Disks

An exemplary electrochemical polishing (ECP) system used to perform the tests described below is shown in FIG. 2B. Similar to the system used to analyze the copper anodic layer, the polishing system 300 included a computer 205, a potentiostat 210, an impedance analyzer 215, and an electrometer 220. The system includes a processing chamber 310 (a cylindrical 3L container), a filter 320, and a cathode 330 (e.g., a copper cathode) placed within chamber 310. The chamber 310 may further include inlet and outlet ports (not shown) to permit the introduction and discharge of the electropolishing composition (solution), as well as control the flow rate of the composition. The chamber 310 is filled with the electropolishing composition such that it covers the cathode 330 and the anode surface 340. A substrate including a conductive surface 340 (such as (1) a copper disk having a surface area of 1 cm² and thickness of 12 mm or (2) a patterned wafer such as a 5 cm×5 cm copper electroplated 200 mm diameter wafer coupon) is positioned in the solution. The solution may be agitated by moving (rotating) the substrate 340, moving (rotating) the cathode 330, or by using a stir bar (not shown). A combination of these approaches could also be used. A potential is applied to the system using, e.g., computer-controlled chronoamperometry. The controlled potentials were the middle points of the limiting current plateau (EL) on the polarization curves, which were measured beforehand.

The system used for ECP of copper disk was same as the one for impedance measurements, except that an Impedance/Gain-Phase Analyzer was not connected. An exemplary process chamber 310 includes a 3-liter cylindrical container. An exemplary filter 320 includes a conical filter. The reason for using the conical filter is to block hydrogen bubbles from reaching the anode surface. 1300 mL solution was used for ECP of each wafer 340. In each case, the surface profiles of the samples before and after ECP were examined with an atomic force microscope (AFM), optical and electron microscopes, as well as a surface profilometer.

Discussion

Electrochemical Impedance Spectra

To understand an electrochemical impedance spectrum, one needs to know the mass transport processes in the electrolyte and the possible structures of the anode-electrolyte interface. In an electrochemical cell with a rotating disk electrode (RDE) and/or circulated aqueous solution, the primary mechanisms for mass transport of ions between anode and cathode are ion migration, convection, and diffusion processes, driven by an electrical field, pressure, and concentration gradient, respectively. See A. J. Bard and L. R. Faulkner, Electrochemical Methods: Fundamentals and Application, 2^{nd} ed (2000), 137, John Wiley & Sons, Inc., New York, incorporated herein by reference in its entirety.

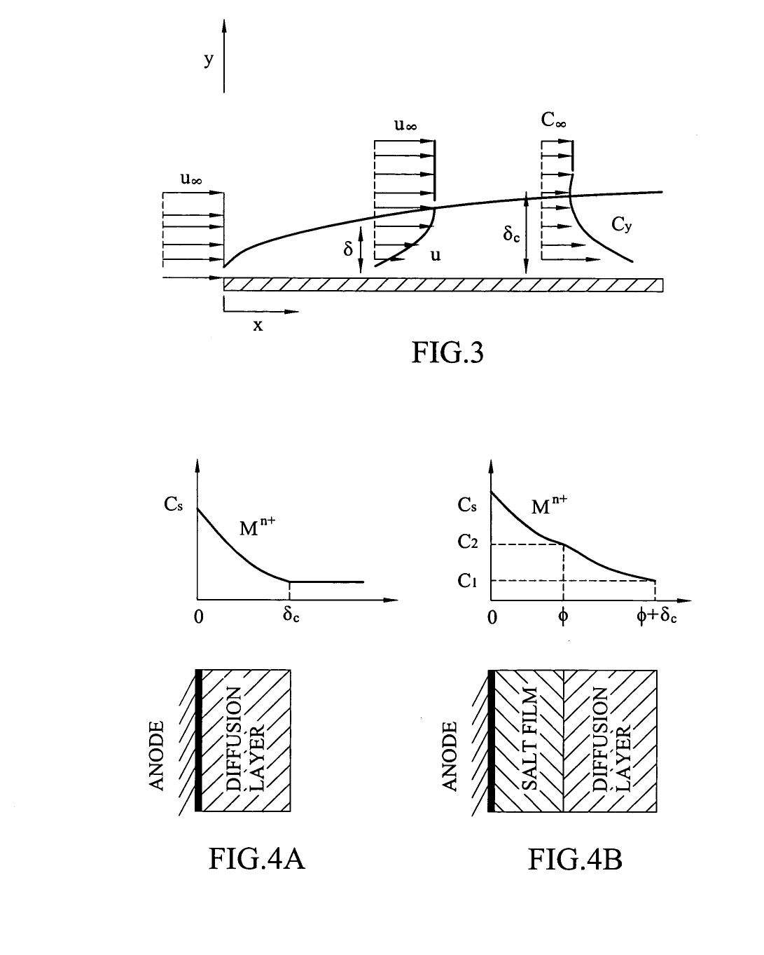

According to hydrodynamics, a boundary layer exists due to the friction between a fluid and a solid surface (See FIG. 3). The thickness of this boundary layer can be determined from

$$δ = \frac{5 x}{\sqrt{{Re}_{x}}} \qquad ( 1 )$$

where

$${Re}_{x} ≡ \frac{ρ {u}_{∞} x}{μ}$$

is the Reynolds number (in range of 10⁵˜3×10⁶ for flow over flat plate), ρ is the density (kg/m³) of the solution, u_{∞} is the fluid velocity (m/s) in bulk solution outside the boundary layer, x is the characteristic length in the flow direction, and μ is the viscosity (kg/m²). See F. P. Incropera and D. P. DeWitt, Fundamentals of Heat and Mass Transfer, 4^{th} ed (1996), 294-351, John Wiley & Sons, Inc., New York, incorporated herein by reference in its entirety. Under our experimental conditions, δ was estimated to be about 30˜160 μm. Outside the boundary layer, mass transport is dominated by convection. Inside the boundary layer, convection is weak and mass transport is dominated by diffusion and migration (if a potential difference exists). The ratio of migration to diffusion depends on electrochemical reaction and the conductance of ions in the solution.

In an electrochemical system, if charge transfer and chemical reaction processes are slower than diffusion and migration, there will be zero concentration gradient in the boundary layer. However, if a potential is applied to the anode within the range of the limiting current plateau, a concentration gradient can develop in the boundary layer (See FIG. 3). In an electrochemical system, the limiting current plateau is the range of potential values that, when applied to the anode, create a system where mass transport becomes the controlling chemical reaction process. Determination of a limiting current plateau is generally known, and is obtained by measuring the anodic polarization curve, i.e., anodic current versus anodic potential plot (not shown). See, e.g., J. Huo et al., Electrochemical Planarization of Patterned Copper Films for Microelectronic Applications, Proc. of 22^{nd} Heat Treating Soc. Conf. and the 2^{nd} Intl. Surface Eng. Congress (2003), 389-397, incorporated by reference in its entirety.

The thickness of the diffusion/migration layer, in case of RDE and considering diffusion only, is

$${δ}_{c} = 1.61 {D}^{\frac{1}{3}} {v}^{\frac{1}{6}} {ω}^{- \frac{1}{2}} \qquad ( 2 )$$

where D is the diffusion coefficient (cm²/s), ν=μ/ρ is kinematic viscosity (cm²/s), and ω is angular frequency of rotation (s⁻¹). The concentration gradient profile produced is illustrated in FIG. 4A.

Further, if a salt film is formed on the anode surface, the film and a diffusion layer next to it may work together as a diffusion/migration barrier, which will limit the diffusion/migration of the dissolved metal cations (Mⁿ⁺) from the anode surface to the bulk solution. As a result, more complicated concentration gradient profiles may develop in the layers, as shown in FIG. 4B. The concentration gradient profiles depend on ion migration and diffusion resistances in the layers.

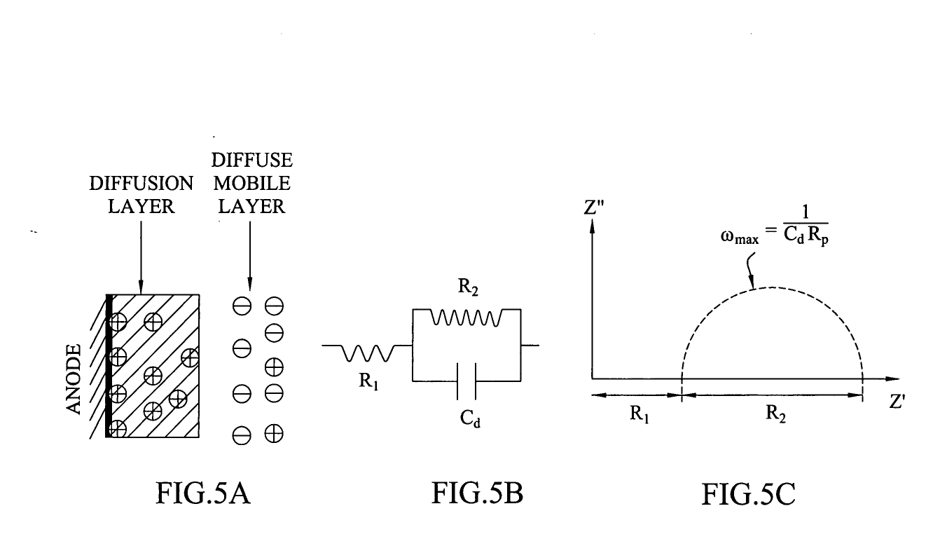

The positive Mⁿ⁺ cations in the salt film/diffusion layer attract nearby anions (A^{m-}) in the solution. The negative ions form a diffused mobile layer (See FIG. 5A), which is balanced by the attraction from Mⁿ⁺ ions in the salt film/diffusion layer and the repulsion from electrons in the anode. This structure is similar to the so-called “double layer”. It behaves like a capacitor (C_{d}) under an alternating current (AC) signal. Thus the equivalent circuit of the electrochemical cell may be represented as shown in FIG. 5B. From this equivalent circuit

R₁=Rₑ+R_{f} (3)

and

R₂=Rₚ+W, (4)

Here, Rₑ and R_{f} are the ohmic resistance of the electrolyte (assume the resistance of contacts and metal wire is negligible) and the salt film, respectively; Rₚ is polarization resistance, and W is Warburg impedance corresponding to the diffusion process. Then, the total AC impedance is

$$\begin{matrix}Z = {R}_{1} + \frac{{R}_{2}}{1 + {( ϖ {C}_{d} {R}_{2} )}^{2}} - j \frac{ϖ {C}_{d} {R}_{2}^{2}}{1 + {( ϖ {C}_{d} {R}_{2} )}^{2}} \\ = {Z}^{′} + {jZ}^{″}\end{matrix} \qquad ( 5 )$$

where \overline{ω} is the angular frequency of the AC signal. See J. Koryta et al., Principles of Electrochemistry, 2nd ed (1993), 301-303, John Wiley & Sons, Inc., New York, incorporated herein by reference in its entirety. A theoretical Nyquist plot (Z′˜Z″) corresponding to Eq. (3) is shown in FIG. 5C.

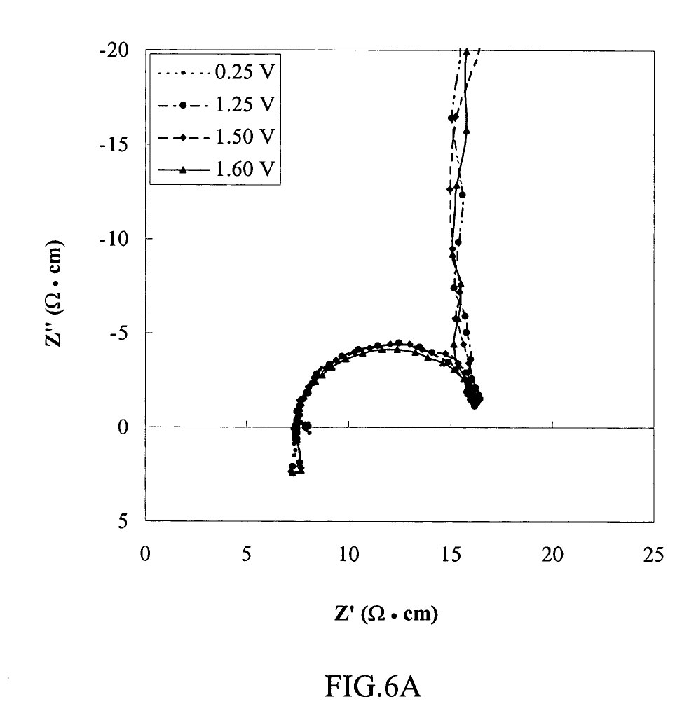

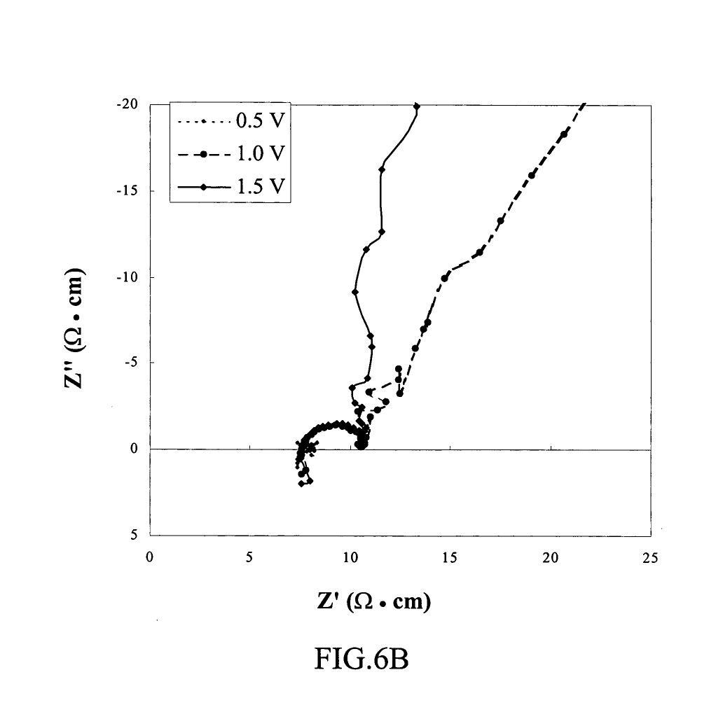

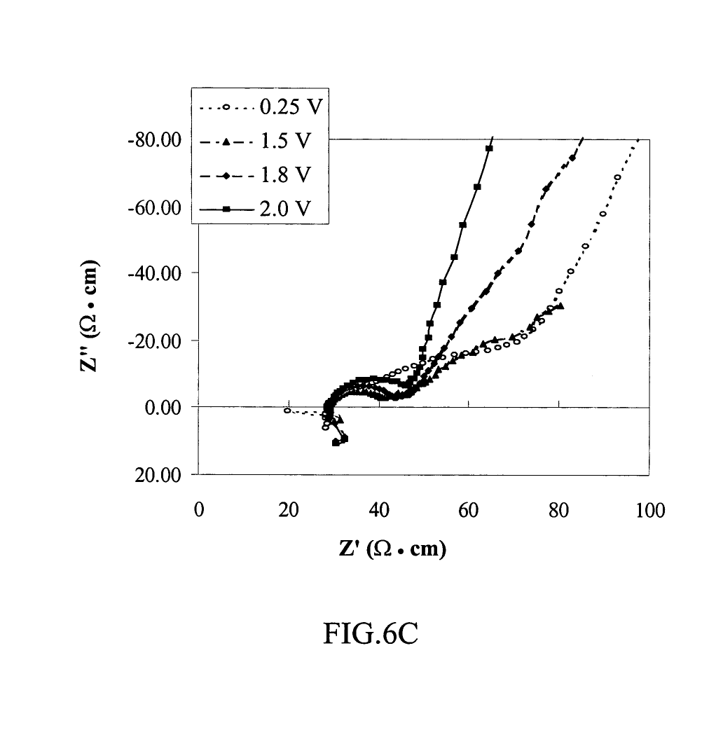

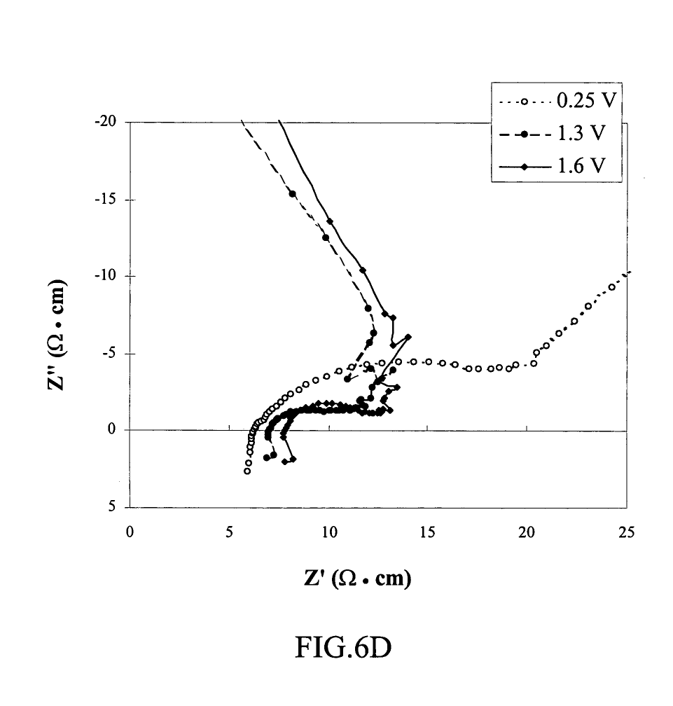

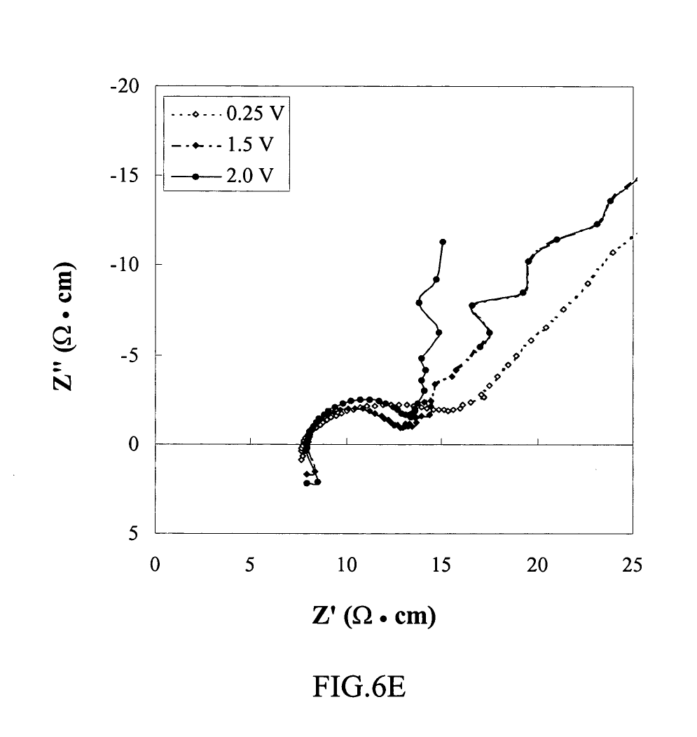

The measured impedance spectra of a copper anode in HEDP solution and phosphoric acid solutions with and without additives are shown in FIGS. 6A, 6B, 6C, 6D and 6E. Specifically, FIG. 6A is a plot of EIS spectra obtained from a planarization process using 85% phosphoric acid. FIG. 6B is a plot of EIS spectra obtained from a planarization process using a 60% phosphoric acid and 1.2 M CuO solution. FIG. 6C is a plot of EIS spectra obtained from a planarization process using a 43% phosphoric acid and 50% ethylene glycol solution. FIG. 6D is a plot of EIS spectra obtained from a planarization process using a 70 vol % HEDP solution (wherein the HEDP contains 60 wt % active acid). FIG. 6E is an EIS spectra obtained from a planarization process using a 60% phosphoric acid and 0.5 M sodium tripolyphosphate solution.

From the spectra, the values for R₁, R₂, and C_{d} were extracted and are listed in Table I. All the potentials in Table I, except 0.25 V, are in the range of limiting current plateau. Since 0.25V is far below the potential range of the limiting current plateau, no anodic film can be formed. Thus, according to the above discussion, R₁ obtained at 0.25V is just the electrolyte resistance (assuming the resistance of contacts and metal wire in the measuring system are neglected), i.e.,

R₁(0.25V)=Rₑ (6)

From the data in Table I, it can be seen that concentrated phosphoric acid and its solutions with additives (copper oxide, ethylene glycol, and sodium tripolyphosphate) all have constant values of R₁ (=Rₑ) at all the tested potentials.

TABLE I
Summary of Measured Impedance Data

| Solution | Potential | R₁ | R₂ | C_{d} |
|---|---|---|---|---|
| (volume percent) | (V) | (Ω cm²) | (Ω cm²) | (μF/cm²) |
| 1. 85% phosphoric acid | 0.25 | 7.5 | 0.5 | 906 |
| | 1.25 | 7.5 | 9.0 | 11 |
| | 1.5 | 7.5 | 9.0 | 14 |
| | 1.6 | 7.5 | 9.0 | 18 |
| 2. 60% phosphoric acid + | 0.25 | 7.6 | 0.4 | 199 |
| 1.2 M CuO | 1.0 | 7.6 | 3.4 | 12 |
| | 1.5 | 7.6 | 3.4 | 74 |
| 3. 43% phosphoric acid + | 0.25 | 29.0 | — | — |
| 50% ethylene glycol | 1.5 | 29.0 | 13.0 | 12 |
| | 1.8 | 29.0 | 15.0 | 11 |
| | 2.0 | 29.0 | 20.0 | 80 |
| 4. 70% HEDP (60 wt % | 0.25 | 6.0 | 14.0 | 180 |
| active acid) | 1.3 | 7.0 | 4.0 | 20 |
| | 1.6 | 8.0 | 4.5 | 11 |
| 5. 60% phosphoric acid + | 0.25 | 8.0 | 9.0 | 88 |
| 0.5 M sodium | 1.5 | 8.0 | 5.0 | 13 |
| tripolyphosphate | 2.0 | 8.0 | 7.0 | 29 |

In contrast, the copper-HEDP system has different values of R₁ at all the three different applied potentials (See FIG. 6D). With these data and Eqs. (4) and (6), the following values for Cu-HEDP system are obtained:

Rₑ=6 Ω,

R_{f}(1.3V)=1 Ω, and

R_{f}(1.6V)=2 Ω.

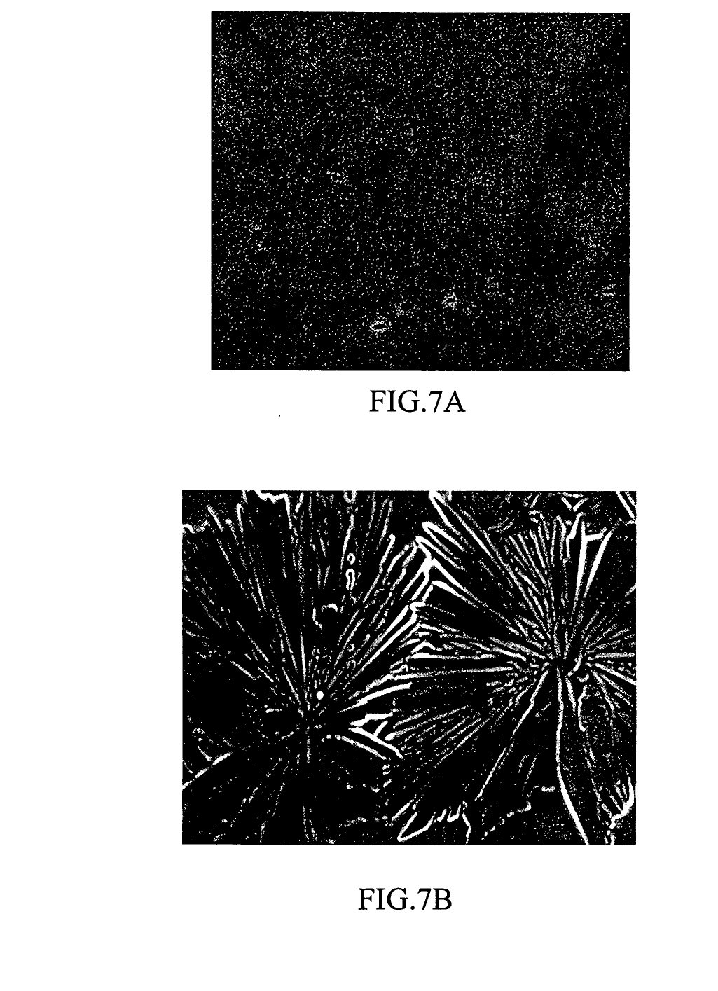

These results suggest the existence of a salt film in Cu-HEDP system, wherein the thickness of the film increases with increasing potential. In the case of phosphoric acid solutions, the above data indicate that no salt film was formed on the copper anode surface. SEM observation, as shown in FIGS. 7A and 7B, further confirmed these results. In particular, a salt film can be seen on the substrate of FIG. 7B, while no salt film appears to be present on the substrate of FIG. 7A. The results for HEDP solution and concentrated phosphoric acid also agree with previous studies. See J. Huo et al., Electrochemical Polishing of Copper for Microelectronic Applications, Surf. Eng., Vol. 19, No. 1 (2003), 11-16; C. Wagner, Contributions to the Theory of Electropolishing, J. Electrochem. Soc., Vol. 101 (1954), 225; and J. Huo, R. Solanki, and J. McAndrew, Study of Anodic Layers and Their Effects on Electropolishing of Bulk and Electroplated Films of Copper, J. App. Electrochem., Vol. 34 (2004), 305-314; each incorporated herein by reference in its entirety.

At a potential lower than the limiting current plateau, the process is mainly charge transfer and/or chemical reaction controlled. So R₂ (0.25V) is mainly polarization resistance Rₚ. On the other hand, over the range of limiting current plateau, Warburg impedance (W) may play a much more important role. The data of R₂ in Table I indicate that in solutions 3, 4, and 5, R₂ increased with an increase of potential within the range of the limiting current plateau. This suggests that diffusion impedance (W) increased as potential increased. So it is very likely that Cu⁺⁺ is the transport limiting species. Since more Cu⁺⁺ ions were produced at higher potential, this resulted in higher concentration gradient in the diffusion layer and thus a higher diffusion/migration resistance. By contrast, R₂ of solutions 1 and 2 remains constant at different potentials within the range of the limiting current plateau. This indicates that Cu⁺⁺ is not the transport limiting species. Instead, acceptors, such as anions or water molecules might be the transport limiting species, as reported.

The data in Table I also show that all the solutions have much higher capacitance at 0.25 V than that in limiting current plateau. The capacitance of all the solutions except solution 4 increased with an increase of potential in the range of the limiting current plateau. Capacitance is defined as

$$C = \frac{ⅆ Q}{ⅆ t} \qquad ( 7 )$$

where Q is charge and t is time. The driving force of an electrochemical reaction is the electrical potential at the electrode surface. So a higher charge transfer rate (e.g., Cu−2e→Cu⁺⁺ on the anode surface) is expected at higher potential. At 0.25V (lower than copper's oxidation potential), Cu⁺⁺ cannot be produced—the double layer is very thin. Thus, the capacitance is expected to be high. This may explain the above phenomena: higher capacitance at higher potential in the range of limiting current plateau and much higher capacitance at potential below limiting current plateau.

However, for solution 4 (HEDP solution), as discussed above, a salt film was formed on the anode surface and its thickness increased with potential in the range of the limiting current plateau. This may reversely contribute to the capacitance too, since

C=εA/r (8)

where A is the area, and ε and r are the electrical permittivity and thickness of the media between the capacitor plates, respectively. From Eq. (8) it can be seen that C decreases with an increase of r. Therefore, when a thicker salt film was formed at higher potential, the capacitance dropped. This explains why solution 4 has a lower capacitance at 1.6V than at 1.3V.

ECP Mechanisms of (Bulk) Copper Disks and Electroplated Copper Films on Trenched Wafers

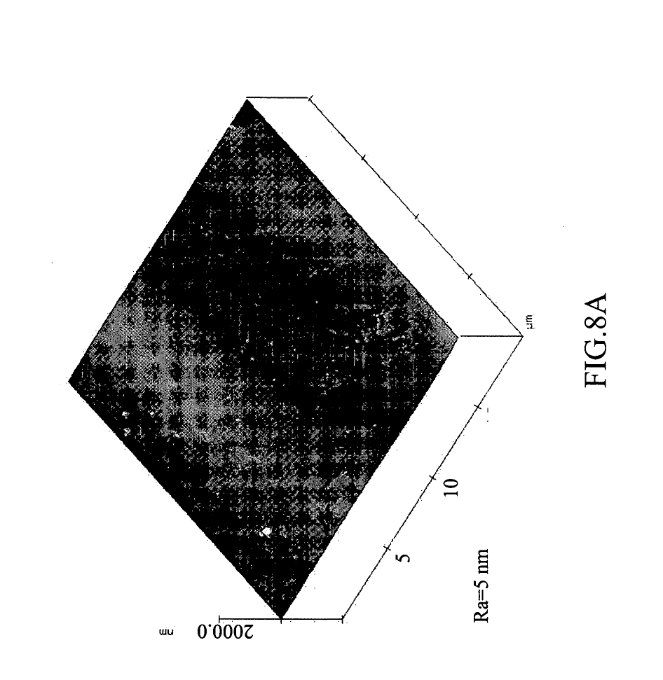

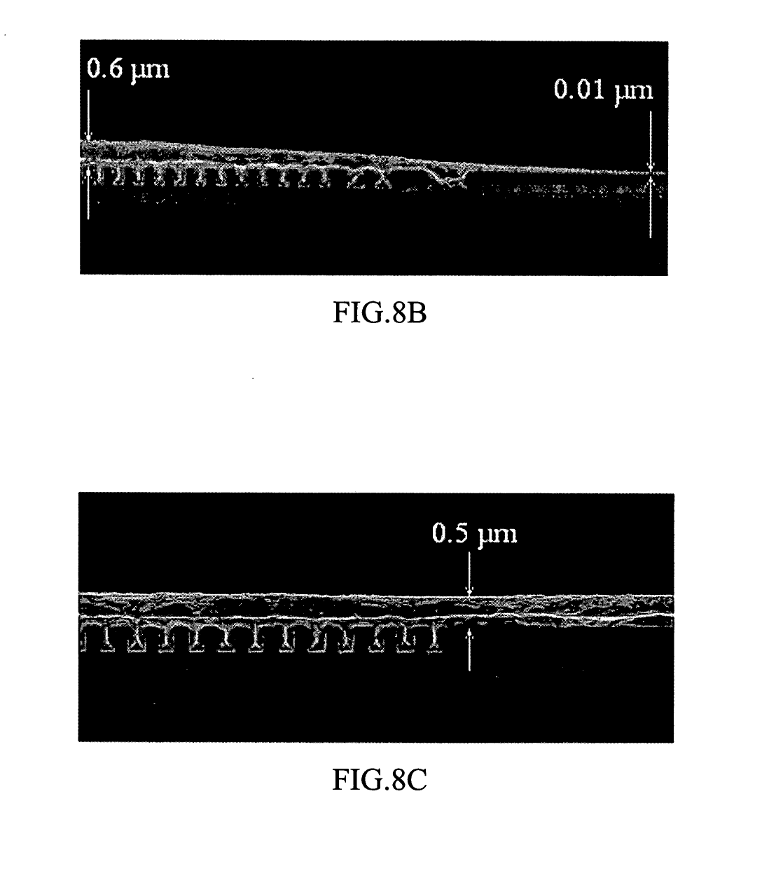

Electrochemical polishing of copper disks was performed with varying concentrations of HEDP, phosphoric acid, and contents of binary systems as follows: (1) phosphoric acid with copper oxide, ethylene glycol, and sodium tripolyphosphate as additives; (2) ethylene glycol with sodium chloride; and (3) sulfuric acid with potassium nitrate. The surface roughness of copper disks before and after ECP was measured with AFM. Typical surface profiles of the copper disks before and after ECP are shown in FIG. 1A and FIG. 8A, respectively. Exemplary ECP results for each chemical system are listed in Table II. The ECP effect is usually evaluated by the change of mean roughness of the surface before and after ECP process. An average roughness (Rₐ) of a solid surface is defined as

$${R}_{a} = \frac{1}{N} {\sum }_{1}^{N} \vert {Z}_{i} - {Z}_{avrg} \vert \qquad ( 9 )$$

where Rₐ is the arithmetic average of the absolute values of the roughness profile ordinates, I is the length of the sample, and Z is the height. Zero line is taken for the lowest Z measured by an AFM. It should be noted that the roughness of copper after ECP in HEDP solution could be much larger if the surface film had not been carefully removed. The results indicate that very good ECP of bulk copper can be achieved with phosphoric acid (or without) the additives and HEDP solutions under potential control at limiting current plateau.

TABLE II
Mean Roughness of Copper Disk After ECP in Various Solutions

| Solution | Current | Time | Roughness |
|---|---|---|---|
| (volume percent) | (mA) | (s) | (nm) |
| 1. 70˜100% phosphoric acid | 12˜50 | 2000 | 4˜9 |
| 2. 70% phosphoric acid + 0.5 M | 45 | 500 | 5 |
| CuO | | | |
| 3. 70% phosphoric acid + 5% | 46 | 500 | 5 |
| ethylene glycol | | | |
| 4. 70% HEDP (60 wt % active acid) | 30 | 800 | 6 |
| 5. 70% phosphoric acid + 0.1 M | 40 | 600 | 7 |
| sodium tripolyphosphate | | | |
| 6. 30% ethylene glycol + 2 M | 50 | 500 | 63 |
| sodium chloride | | | |
| 7. 20% sulfuric acid + 0.1 | 70 | 300 | 72 |
| potassium nitrate | | | |

Nevertheless, the electrochemical polishing of EP copper film on silicon wafers exhibit different characteristics in HEDP and phosphoric acid solutions. FIGS. 1B and 1C, FIG. 8B, and FIG. 8C show the surface topography and cross-section of such a copper film before and after ECP in phosphoric acid and HEDP solutions, respectively. Bumps over dense structures were left behind after ECP of wafer coupons with phosphoric acid. As shown in FIG. 8B, the area over the apertures (e.g., trench or via) still had 0.6 μm thick of Cu film left, while the Cu film over an area without an aperture had been totally removed. In contrast, a substantially planar surface was produced in HEDP solution, as shown in FIG. 8C. To explain this phenomenon, it is necessary to have a better understanding of the ECP mechanisms

As discussed above, leveling can be achieved under ohmic control or mass transport control. Under ohmic control, current density (J) is determined by the electrolyte resistance between the electrodes:

$$J = \frac{V}{{R}_{e} A} \qquad ( 10 )$$

where V (=V₁−V₀) is the potential difference between anode and cathode. Since

$${R}_{e} = {ρ}_{e} \frac{l}{A} \qquad ( 10 a )$$

where ρₑ is the resistivity of the electrolyte and/is the distance between the cathode and anode, Eq. (10) may be rewritten as

$$J = \frac{V}{{ρ}_{e} l} \qquad ( 11 )$$

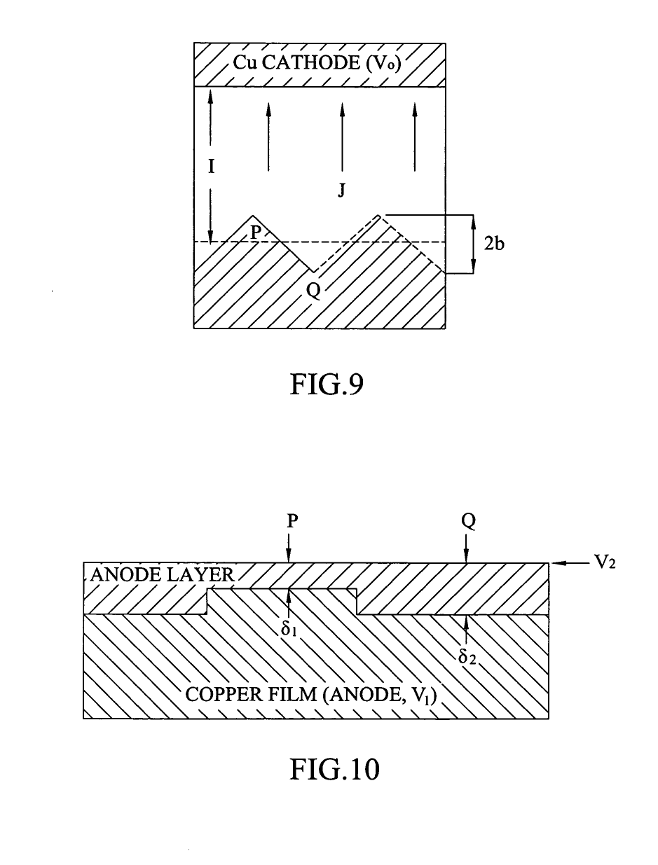

From Eq. (11) it can be determined that the current density (Jₚ) at protruding point P is higher than the current density (J_{Q}) at recessed point Q due to the difference (2b=Iₚ-I_{Q}) of inter electrode distance, as shown in FIG. 9.

Surface removal rate (or polishing rate, Rₚ, cm/s) may be expressed as

$${R}_{p} = \frac{JM}{nFd} \qquad ( 12 )$$

where M is the atomic weight (63.5 g for Cu) and d is the density of the anode material (8.96 g/cm³ for Cu), n (2 for Cu−2e→Cu⁺⁺ reaction) is the number of electrons transferred in the oxidation reaction of an anode atom, while F (=96485 C) is Faraday constant. Substituting Eq. (11) into Eq. (12), results in

$${R}_{p} = \frac{MV}{nFd {ρ}_{e} l} \qquad ( 13 )$$

For given electrode potential, anode material, and reaction,

$$\frac{MV}{nFd} = f$$

is a constant.

Therefore, ohmic macrosmoothing, the difference of the removal rate between protruding point (P) and recessed point (Q), depends on the surface profile and can be expressed as

$$∇ {R}_{p} = {R}_{P} ( P ) - {R}_{P} ( Q ) = f \frac{2 b}{{ρ}_{e} ( {l}^{2} - {b}^{2} )} \qquad ( 14 )$$

Equation (14) indicates that larger surface roughness, closer electrodes (i.e., smaller I), and smaller resistivity of the electrolyte result in better leveling effect.

Assuming ρₑ=10 Ω-cm, 2b=0.5 μm, I=20 cm, and V=2V, ∇Rₚ was calculated to equal 9.18×10⁻⁹ μm/s, which is negligible compared to the average removal rate Rₚ=4.4×10⁻³ μm/s at limiting current i_{L}=12 mA for 85% phosphoric acid solution. This indicates that the ohmic leveling effect is negligible under normal wafer ECP conditions, if an anode layer does not exist or if the layer conforms to the surface (i.e., micro profile).

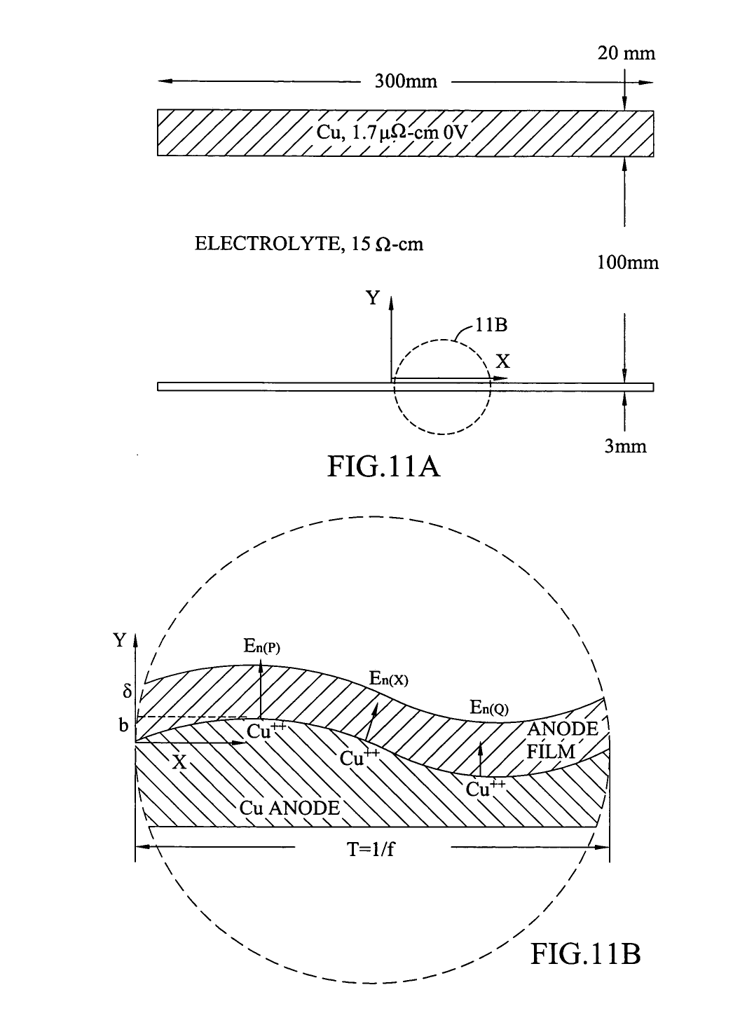

Nevertheless, the ohmic leveling effect can be noticeable under certain hydrodynamic conditions, if a non-conformal anodic layer that has a flat layer/electrolyte interface (i.e., macro profile) is formed on the anode surface (See FIG. 10). In this case, the current density is determined by the anode layer, since the process is mass transport controlled by the anode layer. Thus from Eq. (13) the following is obtained:

$$∇ {R}_{p} = {R}_{P} ( P ) - {R}_{P} ( Q ) = f \frac{{δ}_{2} - {δ}_{1}}{{ρ}_{f} {δ}_{1} {δ}_{2}} \qquad ( 15 )$$

where ρ_{f} is the electrical resistivity of the anode layer, δ₁ and δ₂ are the thickness at point P and Q, respectively (See FIG. 10). Assuming δ₂=0.5 μm, δ₁=0.25 μm, ρ_{f}=2×10⁴ Ω-cm (estimated from the above EIS measurement, in the case of 70% HEDP solution (60 wt % active acid)), and V=V₂−V₁=0.2V (voltage across the anode layer), ∇Rₚ was calculated to be approximately 0.07 μm/s, according to Eq.

(15). In comparison, the average removal rate Rₚ≈0.01 μm/s at limiting current i_{L}=30 mA for 70% HEDP solution (60 wt % active acid). In other words, the removal rate at protruding point (P) is about seven times higher than the average removal rate on the flat area due to ohmic leveling effect. Eq. (15) indicates that ohmic leveling effect can be enhanced by increasing the thickness of the anode layer and lowering its resistivity.

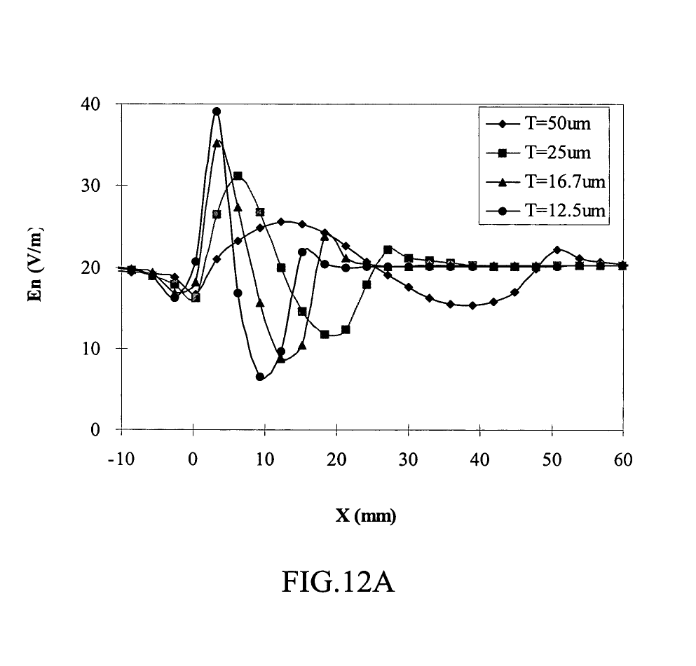

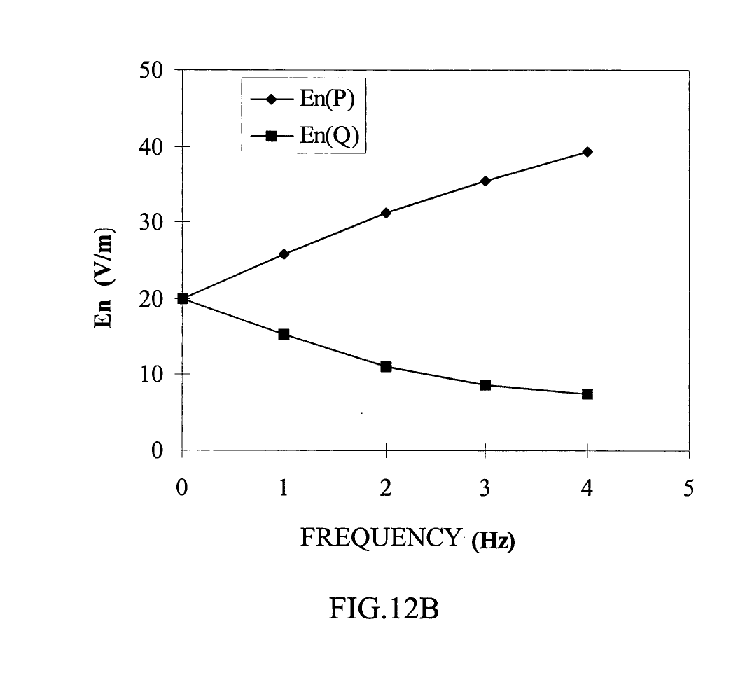

Another geometrical-dependent leveling mechanism results from migration, which is due to the electric field distribution on a rough surface. It is known that an arbitrary two-dimensional surface profile can be described by a Fourier sine series where the individual Fourier coefficients behave independently. Accordingly, the electric field distribution along a sinusoidal surface can be calculated. A sine waveform is located at the center of the anode surface in a 2D electrochemical cell, which has parameters close to an actual 300 mm wafer polishing system (See FIGS. 11A and 11B). This simulation was performed using a boundary element simulation software. The simulation data (See FIG. 12A) indicates that the amplitude of normal electric field (Eₙ) varies along the sinusoidal surface, similar to the shape of the surface profile except at the origin and end points of the sine waveform where a sharp geometric change occurs. For certain amplitude (b) of the sine wave, the difference of the normal electric field Eₙ(P) at the peak point P and Eₙ(Q) at the recessed point Q increases as the wavelength (T) decreases (i.e., the frequency f increases), as indicated in FIG. 12B. The orientation of the normal electric field depends on the location too. At peaks and valleys, (points P and Q), Eₙ points perpendicular to the cathode, and deviates from this direction at other locations.

Once a copper atom is oxidized to Cu⁺⁺ on the anode surface, a force

F_{E}=qE (16)

acts on the Cu⁺⁺ resulting from the electric field Eₙ. As a result, Cu⁺⁺ ions tend to move away from the anode surface towards cathode under the force

F=F_{E}−Fᵣ=qE−Fᵣ (17)

where q is the charge of Cu⁺⁺ and Fᵣ is the resistance as Cu⁺⁺ ions move through the anode film and the solution. According to Newton's second law of motion, the Cu⁺⁺ ions accelerate at a=F/m, and therefore migrate a distance

$$s = \frac{1}{2} {at}^{2} \qquad ( 18 )$$

in time t. From the above three equations, one can estimate the velocity of Cu⁺⁺ migration

$$v = \frac{s}{t} = \frac{1}{2 m} ( {qE}_{n} - {F}_{r} ) t \qquad ( 19 )$$

where m is the mass of Cu⁺⁺.

In bulk solution, F_{E} is negligible compared to the convection force (F_{c}) when a forced convection is applied by stirring or circulation. Nevertheless, it may play an important role under mass transport control when a stable anode surface layer exists. The surface layer may be a solid film and/or a boundary layer with concentration gradient of cations or acceptors, as discussed, supra.

The magnitude and orientation distribution of the electric force Eₙ along the surface favors the diffusion of Cu⁺⁺ at the peak areas where Eₙ has the highest value Eₙ(P) and points towards the cathode. Therefore, Cu⁺⁺ at peak area have the highest migration speed according to Eq. (19). In contrast, Cu⁺⁺ in the valleys have the slowest migration speed. Consequently, a leveling effect is reached.

Since surface removal rate Rₚ is proportional to v, i.e., Rₚ=α v (where α is a constant) and so the difference of the removal rate between protruding point (P) and recessed point (Q) is

∇R_{P}=Rₚ−R_{Q}=α(νₚ−ν_{Q}) (20)

The smoothing effect may be obtained from Eqs. (19) and (20):

$$∇ {R}_{p} = \frac{α q}{2 m} [ {E}_{n} ( P ) - {E}_{n} ( Q ) ] t \qquad ( 21 )$$

The conclusion based upon Eq. (21) and FIG. 12B is that ECP, due to ion migration mechanism, leads to surface profiles of longer waves that disappear slower than the shorter waves.

The ECP effect due to diffusion, driven by the concentration gradient, has the same tendency. The details were discussed by Wagner (above), which calculated the dissolution speed of copper according to diffusion law (Fick's second law) under mass transport controlled and acceptor mechanism conditions.

From the above discussion, it can be seen that better ECP effect can be achieved at sharper geometrical profiles, due to ion migration or diffusion. This explains why very good ECP effect was obtained from all the solutions with copper disks, which have sharp surface profiles (See FIG. 1A). However, ECP effect is largely reduced in case of gentle surface profiles, such as the surface features of electroplated copper films on a patterned wafer, as shown in FIG. 1B. On the surface of electroplated copper films, large pads and wide stripes were about 0.2˜0.5 μm higher than other areas and had gentle geometrical changes, especially after a period of ECP process. Therefore, due to gentle surface undulation, and/or to the lack of an ion migration mechanism (e.g., water molecules instead of Cu ions as the mass transport control species), the polishing rates at protruding areas and at recess areas were not very different in phosphoric acid, as shown in FIG. 8B.

However, the situation changes when a salt film with certain value of electrical resistance is formed on the anode surface. If a non-conformal (macro profile) anodic layer is formed on the anode surface as shown in FIG. 10, a potential difference must exist across the layer. Due to the difference in thickness of the layer, the migration of Cu⁺⁺ at point (P) where anode layer is thinner (δ₁) has shorter distance to reach the bulk solution than those at the point (Q) where anode layer is thicker (δ₂). Therefore, the removal rate at protruding areas is higher than recessed parts due to ion migration mechanism and ohmic smoothing effect (as discussed above) in the salt film/diffusion layer, even though the surface has a gentle profile.

The surface profile of the anode layer, depending on the viscosity of the layer and the convection conditions of the electrolyte, is crucial for ECP of copper films on the patterned silicon wafers. Macro profile is a favorable condition for ECP. For micro profile, ECP effect strongly depends on the frequency of the sine waves (undulations) involved on the surface profile. Formation of anodic film of copper compound in HEDP solutions seems favorable in macro profiles. At all events, mass transport control is the prerequisite condition. For this reason, potential control is the technique normally used to guarantee mass transport condition due to a wide window (E_{L}) of operation. Comparatively, current control is seldom used due to the difficulty to maintain mass transport condition since there is not much of a window (i_{L}) of operation. See, e.g., J. L. Fang and N. J. Wu, XPS and AES Studies of The Composition of Viscous Liquid Film on Electropolished Copper Surface J. Electrochem. Soc., Vol. 136, No. 12 (1989), 3800-3803, incorporated herein by reference in its entirety.

For patterned substrates including a layer of conductive material (e.g., trenched silicon wafer electroplated with a copper film), effective planarization is achieved using an electrochemical polishing composition including 1-hydroxyethylidene-1,1-diphosphonic acid (HEDP). The form of HEDP is not particularly limited. For example, it may be provided in solution. In one exemplary embodiment, the HEDP is provided in solution having an active acid amount of about 40 wt % to about 70 wt %. In another exemplary embodiment, the HEDP solution is a near-saturated solution. That is, the amount of active acid (weight %) in the solution (i.e., the maximum amount of HEDP dissolved in a given solvent) is the maximum amount obtainable for that solvent. By way of example, in an aqueous solution, the maximum amount of HEDP dissolvable in water (and thus the maximum amount of active acid) is about 65 wt % to about 68 wt %. In addition, the HEDP may be dissolved in solvents other than water (e.g., methanol, ethylene glycol, and acetic acid, as well as other organic acids and alcohols, including those that are weaker acids than HEDP), or in mixtures of water and another solvent, in order to achieve HEDP concentrations greater than those achievable in water alone. Commercially available examples of HEDP include C-QUEST H-60 available from Compass Chemical International, Inc. (Lombard, Ill.) and Dequest® 2010 from Solutia, Inc. (St. Louis, Mo.). Both of these commercial examples include active acid concentrations of about 60 wt %.

The electrochemical polishing composition may comprise HEDP alone (as described above), or may contain conventional additives such as additional electrolytes. Examples of electrolytes include acid based electrolytes such as phosphoric acid based electrolytes, sulfuric acid based electrolytes, acetic acid based electrolytes, other suitable electrolytes, and combinations thereof. Examples of phosphoric acid based electrolytes include phosphoric acid (H₃PO₄) and potassium phosphate (K₃PO₄). Examples of other suitable electrolytes include salts, acids, bases, or other compounds forming a viscous boundary layer in which copper ions are sparingly soluble. In addition, other conventional additives such as chelating agents, corrosion inhibitors, and pH adjusting agents. When other additives are present, the concentration (% volume) of HEDP in the composition is not particularly limited. By way of example, the amount of HEDP should be sufficient to form an electrically resistive, viscous salt film near the anodic surface during ECP. By way of further example, the amount of HEDP in the electropolishing composition may be about 40% or more, preferably about 60% or more, and even more preferably about 70% or more.

Controlling both the amount of active acid (wt %) in the HEDP and the amount of HEDP (vol %) in the electropolishing composition controls the total amount of active acid in the electropolishing composition. Using the above-mentioned, exemplary values for the active acid in the HEDP in combination with the exemplary values for the amount of HEDP in the electropolishing composition, it can be seen that the resulting amount of active acid in the electropolishing composition may be from about 16% to about 49% (by volume or weight). By way of specific example, when the amount of active acid in HEDP is 60% by weight, and the concentration of HEDP in the electropolishing composition is 70% by volume, the total amount of active acid in the electropolishing solution is 42%.

Additionally, certain parameters may be considered during the processing of the substrate to optimize the leveling effects (i.e. the brightening) of the HEDP-containing polishing solution. These parameters include current density, process time, flow rate, inter-electrode distance, temperature, and prevention of bubble formation along the conductive material surface.

To achieve the desired brightening effect, electropolishing should be performed in the potential range of the limiting current plateau. Applying anodic voltages within this range maintains the dissolution of the conductive material within a mass-transport-limited regime (also called a steady state), and thus suppresses crystallographic etching. Typically, the thickness of the conductive material layer to be removed from a patterned silicon wafer is about 1 μm. So if the limiting current applied is too high, the conductive material will completely dissolve before an anodic layer is formed. By way of example, in ECP of a patterned substrate with a conductive material layer (e.g., a trenched silicon wafer electroplated with a copper film), the applied voltages may be about 0.5 volts to about 3 volts. In another exemplary embodiment, the resulting current density may be about 30 mA/cm² or less, and preferably about 10 mA/cm² or less. These values maintain the process within the limiting current plateau and, consequently, maintain process conditions within the mass transport limited (steady state) regime. This, in turn, provides a desired rate of removal of the conductive material and, consequently, facilitates planarization.

Additionally, once an electric potential is applied, it is desirable to keep the transition period (i.e., the period time from the initial application of voltage to when the current limiting plateau is achieved) as short as possible. By way of example, transition times experienced in the experiments discussed above were in the range of about 50 to about 100 seconds. Shorter transition times are possible, and depend on process conditions, the type of electrochemical cell, etc.

The processing time is not particularly limited, and varies depending on the current density, the thickness of the layer of conductive material to be planarized, and the desired degree of planarization. The element including a patterned layer is typically exposed to the electropolishing solution until the bumps are substantially dissolved, and a planar, substantially uniform surface is achieved. Care should be taken, however, to avoid over processing and/or the stripping of the layer of conductive material from the substrate.

The flow rate within the process chamber may also affect the brightening effect of the processing system. If the flow rate is too low, the ECP uniformity will be poor. If flow rate is too high, the anodic layer will can be damaged and thus no ECP effect can be achieved. The flow rate (solution circulation) can be controlled using a pump and/or by rotating the anode disk. Though not particularly limited, a preferred flow rate should produce uniform ECP effects over a large area of anode surface and a macro profile of the diffusion layer and the salt film on anode surface during ECP.

The distance between the electrodes (the inter-electrode distance) can also affect the brightening of the conductive material layer. Ohmic leveling effect can be increased by decreasing inter electrode distance. For example, decreasing the inter-electrode distance from 20 cm to 0.1 cm increases the ohmic leveling effect by more than 40,000 times (from 9.18×10⁻⁹ μm/s to 3.67×10⁻⁴ μm/s). If the distance, however, is too small, the solution circulation becomes poor. Additionally, when inter-electrode distance is small, gas bubbles reach anode surface. While not particularly limited, the inter-electrode distance may be about 10 cm to about 50 cm.

Additionally, to achieve the optimum brightening effects, care should be taken to prevent gas bubbles from reaching the anode surface. If the hydrogen bubbles reach the anode surface, they may produce pits or particles on the surface. It is challenging to prevent gas bubbles from reaching the anode surface. A filter between anode and cathode may resist gas bubbles from reaching the anode surface. Selecting a finer porosity for the filter results in a better filtering effect. But it also resists solution circulation. An electrochemical cell with vertical electrodes and filter close to anode favors resisting hydrogen bubbles from reaching the anode surface. Placing the filter close to anode has two benefits. First, larger surface area of solution allows hydrogen bubbles to get out of the solution. Secondly, hydrogen bubbles become larger when they reach the filter. So a filter with larger hole size can be used, which allows better solution circulation.

Finally, temperature can affect factors of the ECP process, including charge transfer, diffusion coefficient, and viscosities of the solution. Therefore, one should be aware that temperature is an experimental variable and can possibly be used to manipulate factors such as limiting current plateau, and anode layer structure when needed. Though not particularly limited, due to costs associated with heating or cooling a processing system, the preferred temperature range is ambient (room) temperature. Copper anodic layers in solutions of 1-hydroxyethylidene-1,1-diphosphonic acid (HEDP), phosphoric acid, and phosphoric acid with organic and inorganic additives were analyzed in situ using Electrochemical Impedance Spectroscopy (EIS) and systems described above and depicted in FIG. 2B. Cu-H₃PO₄ and Cu-H₃PO₄+CuO systems have identical AC impedance spectra at all the tested potentials. Cu-H₃PO₄+C₂H₆O₂ and Cu-H₃PO₄+H₅Na₅O₁₀P₃ systems have AC impedance spectra with the same points of origin but different diameters of Nyquist semicircles at varying potentials. The Cu-HEDP system has very different AC impedance spectra at different potentials. Analysis of these spectra suggests that a salt film was formed on the copper anode surface in HEDP while no salt film was formed in the other solutions. The analysis also suggests that Cu⁺⁺ was the mass transport controlling species in solutions containing HEDP. Water molecules are likely the mass transport controlling species in solutions of phosphoric acid and phosphoric acid with copper oxide.

In electropolishing of bulk metal surfaces, the main objective is to remove very rough features such as sharp points. Gentle undulations in the surface do not affect its apparent brightness and are acceptable in many applications. However, in the case of ULSI fabrication, it is desirable to have a surface that is rigorously and substantially planar, having, for example, an average roughness (Rₐ) of about 0.01 μm to about 0.03 μm across the surface of the wafer. Otherwise, discontinuous metal removal will result, leaving islands of conductive material on the substrate.

Very good electropolishing results (surface mean roughness Rₐ<10 nm) of bulk metal (e.g., copper) were obtained in all the above solutions. Bulk materials, however, have a topography that is different from a patterned substrate. Specifically, a bulk copper surface has sharp undulations (FIG. 1A). Patterned substrates such as trenched silicon wafers have a smoother, gently undulating surface (FIG. 1C), which includes a series of bumps and pads with heights ranging from about 200 nm to about 500 nm high (FIG. 1B). As a result, electropolishing of electroplated copper films on patterned silicon wafers yields different results. The gently protruding areas are not planarized in an ECP process using a solution containing only phosphoric acid as the electrolyte. A good planarization effect, however, was obtained in solutions containing an effective amount of HEDP as the electrolyte. The reason for this difference is believed to be the result of a salt films forming along on the surface of the anode (substrate). This benefit of a salt film with non-conformal surface profile on the anode is attributed to ion migration and ohmic leveling effects. If the surface layer has a profile that conforms to the anode surface, the ECP effect is less sensitive to the sharpness of the surface fluctuation, and even relatively gentle surface fluctuations can be removed. In polishing bulk copper metal—for example, to improve its appearance—this advantage is not important, as gentle fluctuations are usually removed by preceding mechanical polishing steps, and they do not strongly affect the surface reflectivity. However, in polishing patterned silicon wafers, there can be no preceding mechanical polishing, because the whole intention of electropolishing is to replace chemical mechanical polishing with a non-mechanical process. Also, on patterned silicon wafers there are usually topographic features like plateaus and gentle undulations, resulting from various processing steps. While these features can be somewhat minimized by fine tuning other processes (e.g., copper electrochemical deposition) they are often imposed by the design of the desired integrated circuit, its interconnect density, etc. and, therefore, cannot be completely eliminated. On the other hand, on patterned silicon wafers, there are relatively few sharp features like those that are dominant on bulk metal surfaces. The main object of polishing patterned silicon wafers is to remove gentle features and therefore the creation and presence of an anodic salt film is particularly important for this removal.

In any copper electropolishing system, when a voltage is applied to the electrodes, the current density and the polishing rate are both high at first, and then drop, reaching substantially constant values (e.g., a transition period in the electropolishing of a copper-electroplated, trenched silicon wafer may be about 10-100 seconds). This plateau arises when the removal of copper from the surface becomes limited by mass transport. To achieve the desired smooth surface, electropolishing must be performed using voltages in the mass-transport-limited regime (also called a steady state).

Mass transport limited operation is achieved in the presence of a boundary layer at the surface. Transport through the boundary layer is governed by diffusion and migration, such that the diffusion or migration rate through the boundary layer is much slower than charge transfer, transport through the bulk of the electrolyte solution, and other processes occurring. Depending on the electrolyte and the nature of the boundary layer film, the species with the rate-limiting transport rate may be copper ions, anions, or water molecules.

The nature of the boundary layer film along the surface of the substrate is important. It may simply be a stagnant resistive liquid layer, or it may include a viscous salt film (probably with a stagnant liquid layer on top). In the case of electropolishing in phosphoric acid, it consists of a stagnant resistive liquid layer. In solutions containing of HEDP, however, clear evidence of a salt film on the surface exists. The current invention observed an isolatable film with HEDP, but no such film with phosphoric acid solution (compare FIGS. 7A and 7B).

The above difference in the physical and chemical characteristics of the film in HEDP vs. phosphoric acid solutions results in a difference in electrochemical behavior, revealed by electrochemical impedance spectroscopy. The resistance of the film increases as applied voltage is increased for HEDP, but not for the phosphoric-acid-based electrolytes. This indicates the presence of a viscous salt film whose thickness increases with applied voltage, in the HEDP electrolyte only.

While one of ordinary skill in the art would not appreciate the particular benefit of a viscous salt film over other types of boundary layers (such as a stagnant resistive layer), the presence of a viscous salt film in HEDP ECP leads to unexpected benefits in polishing patterned substrates such as copper electroplated, trenched silicon wafers. The benefit of the viscous salt film is that it facilitates ECP through migration and diffusion mechanisms. It is thin and has a large voltage drop across it, even when compared to the boundary layer. For example, it was observed that the hydrodynamic boundary layer is estimated to be 30-160 microns thick, whereas the salt film may be less than 1 micron thick. A voltage drop is present across this thin layer, due to its high resistivity and the low migration (i.e. diffusion under the influence of an applied potential rate of copper ions through it). The salt film must remain sufficiently fluid that its surface is perfectly level and does not follow the undulations of the underlying surface, yet sufficiently viscous to have a high resistivity. Both of these conditions are likely satisfied with HEDP.

The removal rate of copper at a point of the surface to be polished is proportional to the electromotive force applied at that point. The difference in removal rate at different points on the surface is therefore proportional to the difference in voltage drop between each point across the salt film. Because the film is thin with a large voltage drop, relatively small differences in surface elevation result in large differences in electromotive force. Thus the presence of a thin, viscous salt film results in the observed superior smoothing of even gentle surface undulations.

While, the aforesaid methods and compositions are particularly useful for electropolishing copper, it is believed that the polishing methods and compositions also may be used for the removal of other conductive materials, such as aluminum, platinum, tungsten, titanium, titanium nitride, tantalum, tantalum nitride, cobalt, gold, silver, and combinations thereof.

Having described a novel method of planarizing patterned substrates, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A method of electropolishing an element comprising:
contacting the element with an electropolishing composition including an electrolyte, wherein the electrolyte comprises 1-hydroxyethylidene-1,1-diphosphonic acid; and
applying an electric potential to the substrate,
wherein the element includes at least one patterned layer and at least one layer comprising a conductive material.

2. The method of claim 1, wherein the element includes, in order, a substrate, at least one patterned layer, and an outermost layer comprising a conductive material.

3. The method of claim 1, wherein the substrate comprises silicon and the conductive material is copper.

4. The method of claim 1, wherein the amount of 1-hydroxyethylidene-1,1-diphosphonic acid in the electropolishing composition is about 40% or more by volume.

5. The method of claim 1, wherein the applied electric potential is an anodic bias sufficient to dissolve at least a portion of the conductive material layer.

6. The method of claim 1, wherein the applied electric potential provides a limiting current value falling within a predetermined limiting current plateau.

7. The method of claim 1, wherein the applied electric potential results in a current density of about 30 mA/cm² or less.

8. The method of claim 1, wherein the applied electric potential results in a current density of about 10 mA/cm² or less.

9. The method of claim 1, wherein the electropolishing composition further includes an additive selected from the group consisting of additional electrolytes, chelating agents, corrosion inhibitors and pH adjusting agents.

10. The method of claim 1, wherein the 1-hydroxyethylidene-1,1-diphosphonic acid comprises a solution having an active acid amount of about 60% by weight or more.

11. The method of claim 10, wherein the solution comprises a solvent selected from the group consisting of water, organic acids, organic alcohols, and mixtures thereof.

12. The method of claim 1 further including forming a salt film along the surface of the conductive layer.

13. A method of electropolishing an element that includes a layer of conductive material, wherein the conductive layer includes an undulating surface having bumps and pads, the method comprising
contacting the element with an electropolishing composition including about 70% or more by volume 1-hydroxyethylidene-1,1-diphosphonic acid;
applying an electric potential to the element; and
applying the potential for a time sufficient to substantially eliminate the bumps and create a planar surface with a substantially uniform topography,
wherein the amount of active acid in the 1-hydroxyethylidene-1,1-diphosphonic acid is about 60% by weight or more.

14. The method of claim 13, wherein the element comprises a copper electroplated silicon wafer including a patterned layer.

15. The method of claim 13, wherein the applied electric potential provides a limiting current value falling within a predetermined limiting current plateau.

16. The method of claim 13, wherein 1-hydroxyethylidene-1,1-diphosphonic acid comprises a solution including a solvent selected from the group consisting of water, organic acids, organic alcohols, and mixtures thereof.

17. The method of claim 16, wherein the solvent is a weaker acid than 1-hydroxyethylidene-1,1-diphosphonic acid.

18. The method of claim 13, further including forming a salt film along the surface of the conductive layer.

19. The method of claim 13, wherein the composition further includes an additive selected from the group consisting of additional electrolytes, chelating agents, corrosion inhibitors and pH adjusting agents.
